(19) United States
(12) Patent Application Publication
(10) Pub. No.: US 2005/0190078 A1
(43) Pub. Date: Sep. 1, 2005

(54) Lighting System

(75) Inventor: Benjamin Guy Salter, Rugby (GB)

Correspondence Address: KIRSCHSTEIN, OTTINGER, ISRAEL;& SCHIFFMILLER, P.C., 489 FIFTH AVENUE, NEW YORK, NY, 10017, US

(73) Assignee: Alstom, Levallois-Perret (FR)

(21) Appl. No.: 10/711,774

(22) Filed: Oct. 4, 2004

(30) Foreign Application Priority Data
Oct. 3, 2003 (GB) 0323254.3

(51) Int. Cl. G08B 21/00

(52) U.S. Cl. 340/945

(57) ABSTRACT

An aeronautical ground lighting system lighting system having a system power supply, a central control unit, and a plurality of lighting installations in which each of the lighting installations is connected to the system power supply in parallel with the other lighting installations and has light emitters and an installation control unit having a data connection to the central control unit capable of receiving signals therefrom, and the installation control unit being arranged to control the brilliancy of the light emitters in response to signals received from the central control unit.

### FIELD OF INVENTION

This invention relates to lighting systems, especially but not exclusively for use in aeronautical ground lighting. It also relates to lighting installations for use in aeronautical ground lighting.

### BACKGROUND OF INVENTION

Aeronautical Ground Lighting (AGL) must supply pilots (and other aeronautical and ground staff) with visual aids in the form of different patterns and colors of lights to aid landing, take-off and maneuvering on the taxiways. The sets of lights providing the visual aids may be spread over a large area, such as the entire length of an airfield runway.

The light is generated in mechanically robust fittings, each of which must produce a defined photometric output, color and spread of light. The light output is varied, in defined brilliancy steps, via a control interface generally in the airfield Visual Control Room (VCR) to adapt the visual aids to the prevailing ambient light and visibility conditions, such as the Runway Visual Range (RVR). In addition to brilliancy control, taxiway lights in particular are controlled by selective switching of groups of lights via a control interface generally in the VCR.

International and national regulations define minimum serviceability criteria for the visual aids, so it is necessary to monitor the visual aids to provide on-off and serviceability information to the VCR. Visual aids may be monitored down to the level of an individual light fitting.

Each fitting has a defined light output for a given current, in order that a precisely defined brilliancy level is obtained from a given light fitting. It is therefore required that a defined current is fed through the light fitting. Accordingly, in the prior art AGL has generally been powered using a series arrangement with a Constant Current Regulator providing a constant current supply. This provides all the light fittings powered from one supply with a constant current.

A typical AGL system according to the prior art can be seen in FIG. 1 of the accompanying drawings. A control section 10, comprising a user interface 12 is located within an airfield Visual Control Room (VCR). This, as discussed above, allows an operator to select which lights to illuminate and at which brilliancy level. This communicates with a supply section 20 typically located in a housing or “sub-station” in the locality of the lighting through communication link 18. Supply section 20 is responsible for the supply of current to the lighting, and supplies the correct amount of current to a series of lighting installations 32.

Within supply section 20, control unit 22 receives instructions from the control section 10 over communications link 18. In order to supply lighting installations 30 with the correct amount of current, each series of lights 30a, 30b which are to have their brilliancy levels separately controlled are connected in series to a respective Constant Current Regulator (CCR) 27a, 27b. These are fed from a constant potential supply 24 and output a constant amount of alternating current over lines 25a, 25b (high voltage cables, generally rated at 2 kV to 5 kV) to the respective series of light installations 30a, 30b. Switches 26a, 26b are placed between constant potential supply 24 and each CCR 27a, 27b such that all lights in a series can be extinguished in the event of a fault or a general shutdown.

Each light installation 32—which may have varying light output characteristics such as beam color, output or spread but is otherwise functionally equivalent as far as the present invention is concerned—comprises an isolating transformer 31 in series with the other lighting installations. This feeds current to the remaining part of the installation at a relatively low voltage and saturates in the event of a lamp open circuit, to enable all other lamps to remain lit.

Each light installation 32 further comprises a light fitting 36, which is mechanically robust and contains light emitting means 38 (generally an incandescent bulb). Accordingly, each light emitting means is driven with a controlled amount of current to light at the correct brilliancy level. Should it be desired to extinguish one or a group of lights, a field switch 37 can be instructed to close by the control means through control line 21, the field switch short-circuiting the light emitting means, with the CCR ensuring that the remaining lights receive a constant amount of current. The control line 21 may be a separate line as shown or may be the lines 25a, 25b.

However, the use of constant current supplies has disadvantages. The series circuit can give rise to high but unpredictable voltages. The floating nature of the voltage on the supply lines 25a, 25b with respect to earth can lull maintenance staff into a false sense of security since a single earth fault in one location can give rise to a high voltage (on the order of several kilovolts) in another previously “safe” part of the circuit. In addition, an insulation failure in an isolating transformer might leave the light output from the associated fitting appearing normal, whereas the voltage in the fitting has changed from a few volts to a few kilovolts. Furthermore, the normal separation of high voltage from low voltage circuits cannot be maintained in the field because of the small size required of the isolating transformers.

Also, the series circuit described is unique to AGL, the general preference in the field of electrical engineering being parallel, constant potential circuits. All equipment associated with such series circuits is specialist and low volume, and hence expensive. This applies not only to the fittings and control interfaces, where specialism cannot be avoided, but also to the CCRs, the power cabling and the isolating transformers.

Maintenance costs are also higher for constant current networks as burying high voltage cables around a typically wet airfield gives rise to higher maintenance requirements than for low voltage constant potential cables. Specialist training is also required particularly for maintenance staff more used to dealing with constant potential circuits.

There have been attempts made at utilizing parallel fed constant potential circuits in AGL (such as the taxiways of Zurich Airport). However, the requirement to keep the current through any given fitting at a precisely defined level requires careful analysis of the voltage drops—including notably that across the cable leading to each lighting installation.

Extending such a network, which will often be desired, requires careful calculation of potentials and is not simply a case of attaching further installations to the end of the power cable. As the network extends, the voltage drop between the ends of a power cable means different fittings would receive different voltages. As the voltage drop increases, different currents would flow through each light fitting, violating the strict brilliancy limits. This effectively limits the length of a network of lights that can be controlled using this type of installation and makes installation over the entire length of a runway (typically several kilometers in length) difficult.

Switching brilliancies is also problematic, as this requires switching to a different constant potential, generally achieved through the use of multi-tap transformers. The number of different levels of brilliancy achievable is therefore restricted.

Accordingly, there is a noticeable prejudice in the art to use constant current series circuits to power aeronautical ground lighting. All common aviation standards presently in force, such as U.S. Federal Aviation Administration (FAA) Advisory Circulars 150/5345-3E, 150/5345-10E and 150/5340-28 and International Electrotechnical Commission (IEC) Standard no. 61822, refer to the use of constant current series fed circuits.

It is known to have airport approach light systems in which sequence flash units are voltage fed, see e.g., the Honeywell ALSF and MALSR Systems as advertised in the Honeywell Airfield Lighting Product Catalog (Airfield Systems Control and Monitoring Systems) at
http://www.airportsystems.honeywell.com.

However, such flash units comprise specialized high-intensity discharge lamp devices and are not relevant to the problem addressed by the present invention.

### SUMMARY OF THE INVENTION

According to a first aspect of the invention, there is provided an aeronautical ground lighting system lighting system comprising:
a system power supply;
a central control unit; and
a plurality of lighting installations,
   in which each of the lighting installations is connected to the system power supply in parallel with the other lighting installations and comprises light emitting means and an installation control unit having a data connection to the central control unit capable of receiving signals therefrom, and the installation control unit being arranged to control the brilliancy of the light emitting means in response to signals received from the central control unit.

Such a lighting system uses a parallel circuit while not requiring a particularly accurate voltage supply, as each lighting installation has an individual installation control unit which may compensate for varying voltages at the lighting installation. The problems associated with a series circuit discussed above have thus been eliminated while the installation control unit provides control over the light output of the light emitting means.

The light emitting means may comprise at least one Light Emitting Diode (LED). LEDs have a longer life and lower power consumption than prior art light emitting means such as incandescent bulbs.

Preferably, the or each installation control unit may have an individual address. Such an arrangement would allow commands to be sent from the central control unit that individually addressed a single installation control unit.

The installation control unit may be arranged to vary the level of light emitted by the light emitting means between a plurality of non-zero brilliancy levels may be on instruction from the central control unit. It may also be arranged to extinguish the light emitting means may be on instruction from the central control unit. These features provide for a flexible lighting system with distributed brilliancy control such that control of brilliancy and illumination can be controlled at the individual light installation level. Accordingly, many light installations, which need not necessarily require their brilliancy levels and illumination to be controlled together, can be powered from the same power supply. Prior art systems have required that the brilliancy levels emitted by the light emitting means are controlled by the voltage or current on the power supply line and as such separate control of brilliancy levels has not been possible. This reduces the amount of cabling and number of power supplies required, further reducing costs.

Each lighting installation may be arranged to cause the light output of the light emitting means to be substantially independent of the voltage supplied by the power supply over a range of voltages about a predetermined nominal voltage. The installation control unit of each lighting installation may comprise an installation power supply, which may be a switched mode power supply, which converts the range of voltages to a predetermined output voltage and/or current for a given brilliancy. This enables the voltages supplied by the power supply to vary at each light installation and allows use of a less accurate system power supply, further reducing costs. In addition, the system may be tolerant to voltage drops across between the system power supply and the light installations and thus conventional problems associated with using a parallel arrangement of light installations have been overcome.

The system power supply may be linked to the light installations by means of one or more power cables. The power supply may provide a center-tapped voltage across the or each power cable, which may provide two live lines maintained at voltages (which may be half the nominal voltage) of opposing polarities to one another with respect to ground, such that the nominal voltage is provided between the two lines. Accordingly, a single fault between one of the line lines and ground will reduce the voltage supplied to each light installation to half the nominal voltage, which may be within the range of voltages over which the light installations can correctly function. As such, the system may become more tolerant to faults and therefore safer.

The nominal voltage may be roughly 110V AC, and the range may be roughly 55 to 260V AC. 110V AC center-tapped supplies are well known in the art as the domestic supply in such areas as the United States of America. Accordingly, the technology is well known and, as such, no special training is required to deal with such a supply. Cabling, power supplies and the like are also likely to be cheaper and more readily available than the bespoke equivalents required by the prior art. Further, such voltage ranges are generally safe to personnel working on them and therefore provide a much lower risk to health.

However, in other embodiments the nominal voltage may be roughly any of the following voltages: 30, 40, 50, 60, 70, 80, 90, 100, 120, 130, 140, 150, 160, 170, 180, 190, 200 (or any voltage in between these).

An interface may be provided, whereby a user may select the brilliancy level or illumination of the lighting installations. This may comprise a control panel, a touch screen, a computer or any other suitable apparatus. It may be linked to the central control unit by means of an interface communications link.

The central control unit may be provided with an installation control link through which it may instruct the lighting installations and which may provide a data connection. This may comprise a separate link to the power cable, and may be a serial link such as an RS485 link. Alternatively, the installation control link may be any of the following: WORLDFIP; CAN; PROFIBUS; MODBUS; INTERBUS-S; any suitable field bus protocol; or any other suitable protocol which may be those described in the international standard IEC 61158 and/or European standard EN 50170.

Alternatively, the installation control link may send signals over the power cable, typically comprising a MODEM at the central control unit and a MODEM at each of the light installations. The skilled person will appreciate that the installation control link may comprise any of the following types of media: a wireless connection; a fiber optic link; the power cables; a separate communication bus such as CAT-5 cabling, co-axial cables or the like.

Irrespective of the type of installation control link used data transmitted over the installation link may be encoded in a robust, noise resistant protocol with built in error correction, for example via a cyclic redundancy check (CRC).

Each installation control unit may be provided with feedback means, arranged to monitor at least one characteristic of the light emitting means. The feedback means may communicate with the central control unit in order to provide a user with feedback that the light installation is functioning correctly. The at least one characteristic may include any of the current passing through the light emitting means, the brilliancy level being emitted by the light emitting means, its temperature and so on.

The central control unit and the power supply may be housed within a structure, typically referred to as a sub-station, in the locality of the light installations. The interface may be located within an airfield Visual Control Room (VCR). The light installations may be located discretely over an area of an airfield, such as a runway or a taxiway, or both. Each light installations may be mounted elevated, that is above ground adjacent to a runway or taxiway, or “inset”, that is mounted semi-flush with a runway or taxiway surface and capable of being rolled over or landed upon by an aircraft).

According to a second aspect of the invention, there is provided a lighting installation for use in an aeronautical ground lighting system, comprising light emitting means, a communication interface arranged to have a data connection made thereto and an installation control unit adapted to control the brilliancy of light emitted by the light emitting means in response to data received at the communications interface and in which the installation is adapted to be powered by a substantially constant voltage supply.

This provides for a lighting installation that may be used in a lighting system according to the first aspect of the invention. By a substantially constant voltage supply, we may mean that the voltage may vary over a range of voltages about a predetermined nominal voltage. In such a case, the installation may be adapted such that the brilliancy level emitted by the light emitting means is independent of the voltage supplied to the lighting installation.

The installation may have any of the features described above with reference to the first aspect of the invention.

### BRIEF DESCRIPTION OF THE DRAWINGS

There now follows, by way of example, an embodiment of the present invention, described with reference to the accompanying drawings, in which:

FIG. 1 shows an aeronautical ground lighting system according to the prior art;

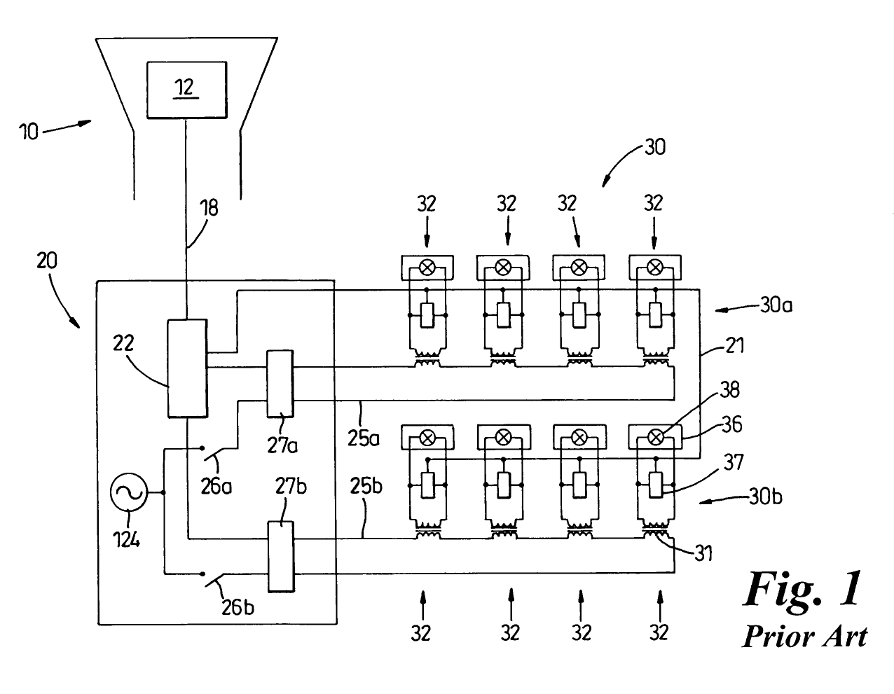

FIG. 2 shows an aeronautical ground lighting system according to an embodiment of the present invention; and

FIG. 3 shows a schematic view of an installation control unit of the embodiment of FIG. 2.

### DESCRIPTION OF EXEMPLARY EMBODIMENTS

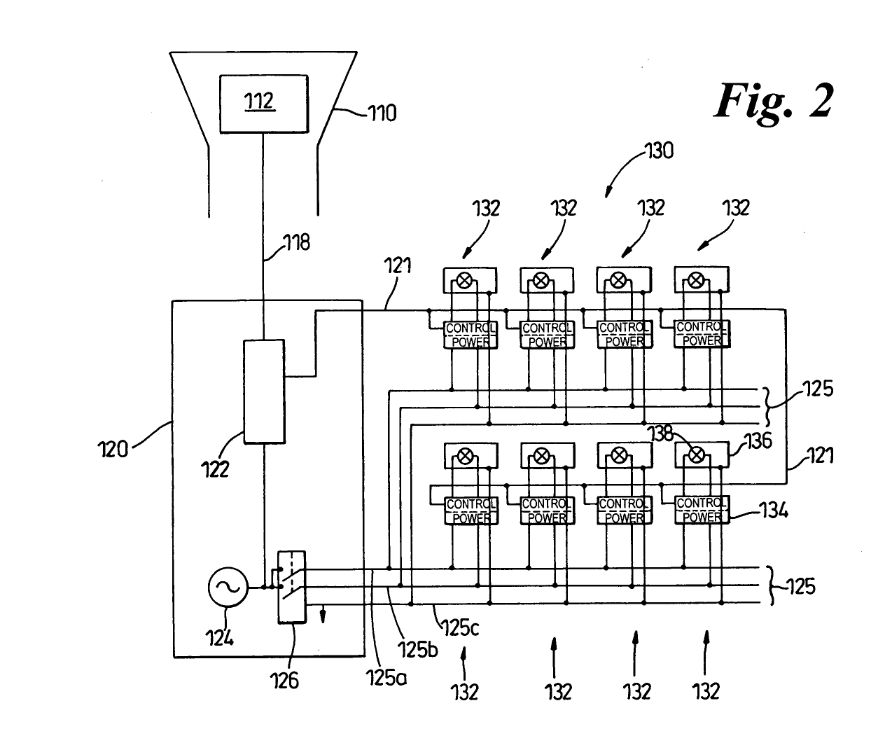

A schematic plan of an aeronautical ground lighting (AGL) system according to the present invention is shown in FIG. 2 of the accompanying drawings. The system comprises three sections: firstly, a control section 110 generally installed in a visual control room (VCR); secondly, a supply section 120 generally installed in the locality of the lighting, typically in an installation known as a “substation”; and thirdly, a lighting section 130 comprising a plurality of light installations 132 spread over an area such as a runway, taxiway or similar.

The control section 110 is, to an operator thereof, functionally equivalent to that of the prior art. The operator can use interface 112 to define the light output by the lighting installations 132 in defined brilliancy steps to adapt the visual aids to the prevailing ambient light and visibility conditions, such as the Runway Visual Range (RVR). As discussed above, the operator can also selectively switch groups of lights to give instructions to pilots of aircraft using the illuminated areas, such as red or green taxiway lights indicating a stop or follow condition respectively. Groups, or even individual lighting installations can be instructed to illuminate or change brilliancy separately from one another.

The selected brilliancy levels and illumination instructions are transmitted over communications link 118 to supply section 120. Communications link 118 is typically an IEEE 802.3 Ethernet link with fiber-optic transceivers at either end of a pair of fiber optic cores. Control unit 122 within the supply section 120 interprets these instructions and transmits commands to each individual lighting installation 132 through control line 121 as will be described below.

Each lighting installation 132 will most likely be separately positioned over the area and have differing light output characteristics such as color, beam intensity, beam spread and so on to provide pilots, other aeronautical staff and ground staff with instructions and information. However, each lighting installation is functionally equivalent as far as relates to this invention but in this embodiment is individually addressable to allow each lighting installation to be individually controlled.

Each lighting installation is provided with power from a constant potential supply 124 of the supply section 120, which provides a system power supply, by a power line 125 comprising a center-tapped roughly 110V AC supply. The power line hence comprises live lines 125a, 125b both providing roughly 55V AC with respect to an earth line 125c, but at opposite polarity to one another. Such a supply is well known in the art and is commonly used as the domestic electricity supply in such areas as the United States of America. As the voltage with respect to ground of either live line 125a, 125b is roughly 55V, such a supply has a good outdoor safety record and cables and other equipment for use with such a supply are cheap and readily available. The individual lighting installations 132 are positioned in parallel along the power line 125.

A miniature circuit breaker (MCB) 126 is provided in the supply section across the supply to isolate lighting installations 132 in the case of a failure or general shutdown of the system. The MCB can be controlled by control unit 122 or may be manually operated by a user at the supply section 120.

Each lighting installation 132 further comprises an installation control unit 134. This takes power from the power line 125 and receives brilliancy and illumination instructions from control unit 122 via control line 121. Control line 121 is typically an RS485 serial communication link. In other embodiments signals may be transmitted along power line 125 using MODEMs at control unit 122 and each installation control unit 134 thus removing the need for the control line 121. A person skilled in the art will appreciate that any appropriate communications link providing communication between control unit 122 and the installation control unit 134 of each lighting installation 132 can be used.

Each lighting installation 132 also comprises a light fitting 136, being a mechanically robust item, designed to withstand the forces and ingress of fluids consistent with its functions. Fittings are generally “elevated”, that is mounted above ground adjacent to runways or taxiways, or “inset”, that is mounted semi-flush with the surface in which it is fitted and capable of being rolled over or landed on by aircraft. The fitting contains a light emitting means 138, being a Light Emitting Diode (LED) or LED cluster selected to have the required light output characteristics. Whilst the installation control units 134 are herein shown as outside the fitting 136, it is envisaged they could also be incorporated within the fitting 136.

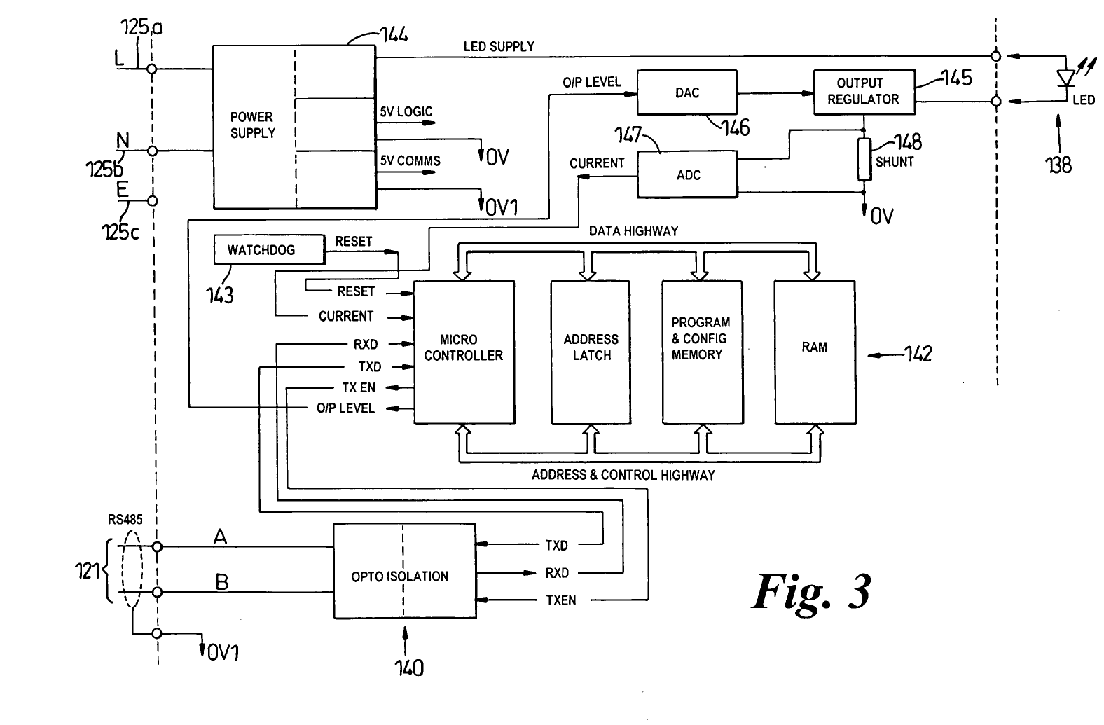

The installation control unit 132 uses the instructions received on control line 121 to illuminate the light emitting means 138 as required and at the required brilliancy. It does this by converting supplying the light emitting means with the correct amount of current at the correct voltage. The installation control unit 132 is shown in more detail in FIG. 3 of the accompanying drawings.

The installation control unit 132 comprises a switched mode power supply 144. This converts any voltage between roughly 55V to 260V AC to a suitable DC voltage for running logic circuits, communications and the light emitting means 138 (typically 5V DC). Signals from the control line 121 pass through an opto-isolator 140 to microcontroller 142. As the person skilled in the art will appreciate, this could be any appropriate microcontroller available in the art suitably programmed. The present embodiment uses a PIC microcontroller 8-bit CMOS flash micro-controller from the PIC-16F87X series, manufactured by Microchip Technology Incorporated although the skilled person will appreciate that other controllers are equally possible.

The microcontroller 142 takes the requested brilliancy and calculates from the required current, either by using a suitable algorithm or by using a look-up table stored in memory, or other suitable method. Such techniques are well known in the art. The required output level is digitally transmitted to Digital to Analog Converter (DAC) 146, which causes output regulator 145 to regulate the correct amount of current through light emitting means 138. A shunt resistor 148 is also included in the current path with the light emitting means 138 such that the current through the light emitting means 138 can be monitored by an Analog to Digital Converter (ADC) 147 as the voltage across the shunt resistor 148. The ADC therefore provides a feedback means. This digitized current reading provides feedback whether the circuit is operating correctly, and is passed back to microcontroller 142 to be transmitted over control line 121 to the control unit 122.

A watchdog circuit 143 is provided, which ensures continued operation of the microprocessor 142 and in case of failure raises a reset flag to reset microcontroller 142.

1. An aeronautical ground lighting system lighting system comprising:
a system power supply;
a central control unit; and
a plurality of lighting installations, each of the lighting installations being connected to the system power supply in parallel with the other lighting installations and comprises light emitting means and an installation control unit having a data connection to the central control unit capable of receiving signals therefrom, and the installation control unit being arranged to control brilliancy of the light emitting means in response to signals received from the central control unit.

2. The lighting system of claim 1, in which the light emitting means comprises at least one light emitting diode (LED).

3. The lighting system of claim 1, in which each installation control unit is arranged to vary a level of light emitted by the light emitting means between a plurality of non-zero brilliancy levels.

4. The lighting system of claim 1, in which each installation control unit is capable of extinguishing the light emitting means.

5. The lighting system of claim 1, in which the light output of each light emitting means is substantially independent of a voltage supplied by the system power supply to the relevant lighting installation over a range of voltages about a predetermined nominal voltage.

6. The lighting system of claim 5, in which the installation control unit of each lighting installation comprises an installation power supply, which converts the voltage output from the system power supply to a predetermined output voltage and/or current to cause the light emitting means to produce a given brilliancy.

7. The lighting system of claim 6, in which the installation power supply is a switched mode power supply.

8. The lighting system of claim 1, in which the system power supply is linked to the lighting installations by means of at least one power cable, in which the power supply provides a center-tapped voltage across the at least one power cable.

9. The lighting system of claim 1, in which the central control unit is provided with an installation control link through which it instructs the lighting installations.

10. The lighting system of claim 9, in which the installation control link comprises a field bus.

11. The lighting system of claim 9, in which the installation control link comprises an RS485 series link.

12. The lighting system of claim 9, in which the installation control link is any one of the following: WORLDFIP; CAN; PROFIBUS; MODBUS; INTERBUS-S; any suitable field bus protocol described in the international standard IEC 61158 and/or European standard EN 50170.

13. The lighting system of claim 9, in which the installation control link comprises the power cable connecting the lighting installation to the power supply.

14. The lighting system of claim 13, in which the installation control link comprises a MODEM at the central control unit and a MODEM at the lighting installation.

15. The lighting system of claim 1, in which each lighting installation is provided with feedback means for monitoring at least one characteristic of the light emitting means.

16. The lighting system of claim 15, in which the feedback means is operative for communicating with the central control unit in order to provide a user with feedback that the lighting installation is functioning correctly.

17. The lighting system of claim 15, in which the at least one characteristic includes any of the following group: current passing through the light emitting means; a brilliancy level being emitted by the light emitting means; and a temperature of the light emitting means.

18. The lighting system of claim 1, in which the control unit and the power supply are housed within a structure in a locality of the lighting installations.

19. The lighting system of claim 1, in which an interface is provided, whereby a user selects a brilliancy level or illumination of the lighting installations.

20. The lighting system of claim 19, in which the interface is located within an airfield visual control room.

21. The lighting system of claim 1, in which the lighting installations are located discretely over an area of an airfield.

22. A lighting installation for use in an aeronautical ground lighting system, comprising light emitting means; a communication interface arranged to have a data connection made thereto; an installation control unit adapted to control brilliancy of light emitted by the light emitting means in response to data received at the communications interface; and a substantially constant voltage supply for powering the lighting installation.

23. The lighting installation of claim 22, in which the lighting installation is constituted such that a brilliancy level emitted by the light emitting means is independent of a voltage supplied to the lighting installation.
